(19) United States
(12) Patent Application Publication
(10) Pub. No.: US 2008/0295172 A1
(43) Pub. Date: Nov. 27, 2008

(54) Method, system and computer-readable media for reducing undesired intrusion alarms in electronic communications systems and networks

(76) Inventor: Khushboo Bohacek, Mountain View, CA (US)

Correspondence Address: PATRICK REILLY, P.O. BOX 7218, SANTA CRUZ, CA, 95061-7218, US

(21) Appl. No.: 11/805,552

(22) Filed: May 22, 2007

(51) Int. Cl. G06F 11/00

(52) U.S. Cl. 726/23

(57) ABSTRACT

A method, system and computer-readable media that enable the employment of an intrusion detection process are provided. This present invention is able to differentiate between certain malicious and benign incidents by means of a two-stage anomaly-based intrusion detection and prevention system. The invented system works at high-speed and with low-memory resources requirements. In particular, the invented method is implemented in a two-stage detector that performs coarse grain detection using sub-profiles 30A-30H (key features extracted from a profile) at one stage and fine grain (detailed behavioral profile) detection at another stage to eliminate unwanted attacks and false positives. Furthermore, in order to suppress specific alarms, the invented system allows the administrator to specify detailed profiles 32A-32H. By using a sub-profile extractor, a sub-profile is extracted, which is then downloaded into the coarse grain detector.

### FIELD OF THE INVENTION

The present invention relates to information technology that enables intrusion detection functionality. The present invention more particularly relates to information technology systems and methods that provide intrusion detection.

### BACKGROUND OF THE INVENTION

Electronic communications networks, such as the Internet, digital telephony and wireless computer networks, are a fundamental infrastructure used to enable a great deal of conventional economic activity. Unfortunately, criminals and hooligans often attempt to disrupt or penetrate the activity of elements of important electronics networks. In particular, many criminals attempt to harvest confidential data for various misuses to achieve improper financial gain. In addition, there exists a diverse group of malicious hackers who are motivated to impede or degrade electronic networks by misguided ideological principles or pointless egotistical reasons.

The protection of electronic communications network from unwarranted intrusion is therefore a major field of endeavor. Significant effort in this field of communications security is directed toward the detection and prevention of intrusions by unauthorized entities.

Most intrusion detection and prevention systems can be divided into one of two classes based on the detection method, namely (1.) communications traffic anomaly detection; and (2.) communications activity signature based detection. Anomaly detection systems typically build a baseline of “normal” behavior of a specific and defined communications network domain, e.g., traffic interaction between the Internet and a corporation's intranet. If the observed activity of a protected network, or element of the protected network, falls by a preset metric beyond the normal behavior baseline of communications activity then anomaly is detected and an alarm is triggered.

Alternatively, a signature based detection system might maintain a database of intrusion-related communications activity patterns that indicate a possibility of the occurrence of a known intrusion effort being directed against the protected network. A signature based detection system might additionally compare one or more of a communications packet's header or payload contents of electronic messages received by the system against the database of intrusion-related communications activity patterns to determine whether a malicious patterns as stored in the database is observed, or partially observed, in the targeted communications domain. If there is a match between observed communications activity of the defined domain and at least one intrusion-related communications activity pattern of the system's database, an intrusion alarm is triggered.

Each of these two classes of intrusion detection system, or “IDS”, has pros and cons. Anomaly detection is better than signature detection in terms of detecting new and previously unknown or undetected intrusion threats. However, anomaly detection systems often generate more false alarms than signature based IDS's.

Anomaly detection systems may characterize normal system behavior into one or more profiles 32A-32H. A behavioral profile 32A-32H, or exception profile 32A-32H, may consist of a comprehensive list or lists of parameters and values that are geared towards the communications activity domain of a monitored target, e.g. a host system, a local area network, and a virtual local area network. Furthermore, an exception profile 32A-32H may be stable and consistent in forecasting the normal behavior range of the target and sensitive to the security concerns of the system administrator of the target. Behavioral profiles 32A-32H can be as simple as one or more threshold levels or as complicated as multi-variate distributions.

Prior art IDS employ various techniques for anomaly detection, many of which are based on different types of behavioral profile. One class of anomaly detectors manage a database of behavioral profiles 32A-32H of malicious behavior and compare the user's or network's behavior to malicious behaviors. This technique may be intended to completely eliminate a need for signature-based detection.

Keeping the behavioral profile database up-to-date with the latest generated profiles 32A-32H of the most novel intrusion techniques is necessary so best enable new threats to be detected by signature-based IDS's. One limitation of the prior art approach is that, for optimal intrusion detection, the intrusion signature database needs to be constantly updated and maintained, and every packet or event needs to be compared against the patterns stored in the database. This activity of matching volumes of packets against large numbers of stored intrusion signature patterns slows down detection of intrusions and may impede target functionality.

The prior art includes U.S. Patent Application Publication No. 20060064508 that teaches a method and system to store and retrieve message packet data in a communications network; U.S. Patent Application Publication No. 20060107055 that discloses a Method and system to detect a data pattern of a packet in a communications network; U.S. Pat. No. 6,715,084 that presents a Firewall system and method via feedback from broad-scope monitoring for intrusion detection; and U.S. Pat. No. 7,127,743 that teaches a comprehensive security structure platform for network managers.

U.S. Pat. No. 7,185,368 and each and every other patent and patent application mentioned in this disclosure is incorporated in its entirety and for all purposes in the present patent application and this disclosure.

There is a long felt need for algorithms and information technology system architectures that automatically identify and classify false alarms and unwanted alarms. There is therefore a long felt need to provide methods and systems that enable detection of intrusion efforts directed against electronics communications systems and networks, while reducing the incidence of undesired or false intrusion alarms and without additionally burdening the computational resources assigned to intrusion detection.

### SUMMARY OF THE INVENTION

Towards this object and other objects that will be made obvious in light of this disclosure, the method of the present invention provides methods and computational systems for application in intrusion detection and optionally intrusion prevention.

The method of the present invention, in certain alternate preferred embodiments, may provide a two-stage anomaly based intrusion detection and prevention system that may be used to differentiate malicious and benign intrusion alarms and to achieve high-speed and low-memory detection with a reduced rate of undesired intrusion alarms.

In particular, a first version, i.e., a first preferred embodiment of the method of the present invention, presents a two-stage detector that maintains sub-profiles at one stage and exception profiles at another stage. The two-stage detector may be applied to directed to reduce unwanted network intrusion, false positives of intrusion alarms and imposing low detection delay. The applicability of the first version may be applied in conjunction with, or within, a scan detector system in order to reduce false intrusion alarms that may be caused by observing peer-to-peer and instant messaging activity in the targeted communications domain. The first version can also be used to reduce certain other undesired intrusion detected related alarms or to reduce unwanted scans.

The first version may be applied in a computer network having a switch and an event correlation computer and comprise: (a.) establishing a library of exception profiles accessible to the event correlation computer, where each exception profile has a record of observable conditions that when detected in combination indicate the potential occurrence of an intrusion attempt; (b.) providing a library of subprofiles to the switch, where each subprofile includes a subset of the observable conditions of a unique exception profile; (c.) enabling the switch to examine communications traffic and determine when the behavior of the communications traffic matches any one of the subprofiles; and (d.) directing the switch to inform the event correlation computer upon detection of a match between contemporaneously detected communications traffic and at least one subprofile.

Certain alternate preferred methods of the method of the present invention provide an intrusion detection system and/or a computer-readable medium that includes machine-readable instructions that direct an informational technology system to perform or instantiate one or more of the aspects of the method of the present invention as disclosed herein.

In certain alternate preferred embodiments of the invented intrusion detection system, invented system includes (1.) a tier-1 intrusion detector; (2.) a tier-2 intrusion detector; (3.) means for setting a threshold-low and a threshold-high; (4.) means for directing the tier-1 intrusion detector to initiate intrusion counter measures when a source exceeds the threshold-high traffic anomaly score; and (5.) means for directing the tier-2 intrusion detector to determine whether to initiate intrusion counter measures when a source's anomaly score exceeds threshold-low traffic anomaly score and does not exceed the threshold-low traffic anomaly score.

The foregoing and other objects, features and advantages will be apparent from the following description of the preferred embodiment of the invention as illustrated in the accompanying drawings.

### BRIEF DESCRIPTION OF THE DRAWINGS

These, and further features of the invention, may be better understood with reference to the accompanying specification and drawings depicting the preferred embodiment, in which:

FIG. 1 is a schematic drawing of an electronic communications network comprising the Internet and an intranet;

FIG. 2 is a schematic drawing of a Tier-1 switch of the intranet of FIG. 1;

FIG. 3 is a schematic drawing of a Tier-2 system of the intranet of FIG. 1;

FIG. 4 is a process chart of the first version that may be implemented by the intranet of FIG. 1, the Tier-1 switches of FIG. 2 and the Tier-2 system of FIG. 3;

FIG. 5 is a schematic block diagrams of the application of a scan detection system residing at Tier-1;

FIG. 6 shows a plurality of working zones for anomaly detection by Tier-1 switches and Tier-2 systems of FIGS. 1, 2 and 3;

FIG. 7 shows a flow chart in schematic block diagram format of an application of the Tier-2 system of FIGS. 1 and 3;

FIG. 8 is a flowchart of a third version of the method of the present invention that may be applied to reduce unwanted intrusion alarms within the intranet of FIG. 1;

FIG. 9 is a flowchart of operations of the Tier-2 system of FIGS. 1 and 3 and in accordance with a fourth alternate preferred embodiment of the method of the present invention;

FIG. 10 is a flowchart of operations of a Tier-1 switch of FIGS. 1 and 2 and in accordance with a fourth alternate preferred embodiment of the method of the present invention; and

FIG. 11 is a flowchart of additional operations of the Tier-2 system of FIGS. 1 and 3 and in accordance with a fourth alternate preferred embodiment of the method of the present invention

### DETAILED DESCRIPTION OF A PREFERRED EMBODIMENT

In describing the preferred embodiments, certain terminology will be utilized for the sake of clarity. Such terminology is intended to encompass the recited embodiment, as well as all technical equivalents, which operate in a similar manner for a similar purpose to achieve a similar result.

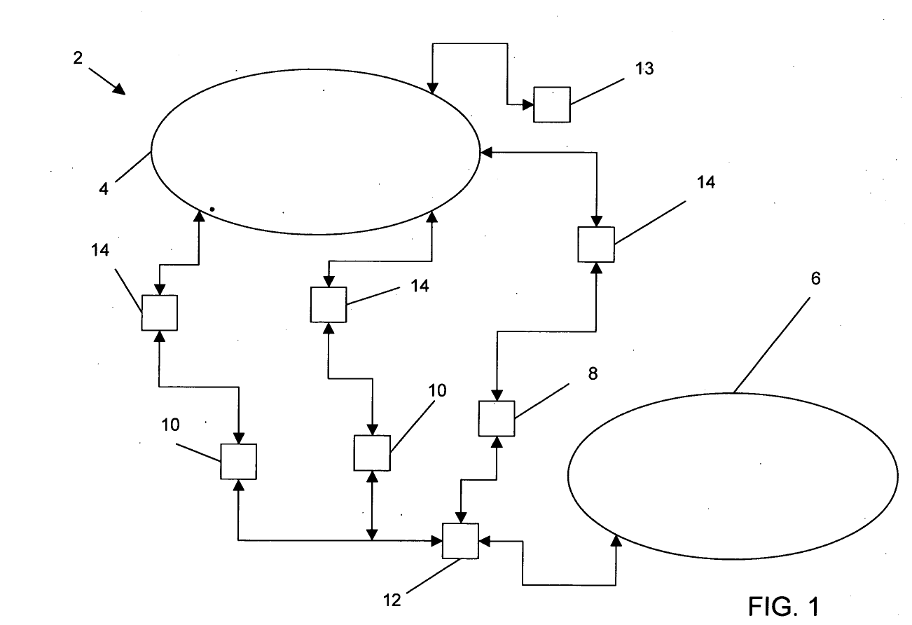

Referring now generally to the Figures and particularly to FIG. 1, FIG. 1 is a schematic of an electronic communications network 2 comprising the Internet 4 and an intranet 6. The electronics communication network may be or additionally or alternatively comprise, additional intranets, an extranet, and/or a telephony system. A first Tier-1 switch 8 and a plurality of secondary Tier-1 switches 10 on the intranet are communicatively coupled to a Tier-2 system 12 of the intranet 6 and one or more Internet portal systems 14 of the Internet 4. The Internet portal systems 14 are configured to transmit electronic messages to and from the intranet 6 and a plurality of source computers 15 of the Internet 4, and in accordance with the Transmission Control Protocol (hereafter “TCP”) as layered on top of the Internet Protocol (hereafter “IP”). The TCP/IP protocols were developed to enable communication between different types of computers and computer networks. The IP is a connectionless protocol which provides packet routing, whereas the TCP is connection-oriented and provides reliable communication and multiplexing.

One or more Tier-1 switch and/or Tier-2 system may dynamically maintain and update an anomaly score for some or each known source computer. Computations to determine whether to issue intrusion alarms by the Tier-1 switches 8 & 10 and/or a Tier-2 system 12 may be at least partly based in view of a source computer's anomaly score. For example, if a particular source computer's's anomaly score is higher than a threshold_low or a threshold_high, the Tier-2 system may be place a higher likelihood that message traffic from the given source is related to an intrusion attempt.

The Tier-1 switches 8 & 10 accept all communications traffic from the Internet 4 and examine the received communications traffic for indications of intrusion attempts. Optionally and additionally, the Tier-1 switches 8 & 10 may be directed by a systems administrator to examine communications traffic originating from the intranet 6 and outbound to the Internet 4 for indications of intrusion attempts.

The communications traffic passing through the Tier-1 switches 8 & 10 may include packets and other message components that are in accordance with e-mail transmissions, Hyper Text Transfer Protocol (hereafter HTTP) and other suitable electronics communications protocols known in the art.

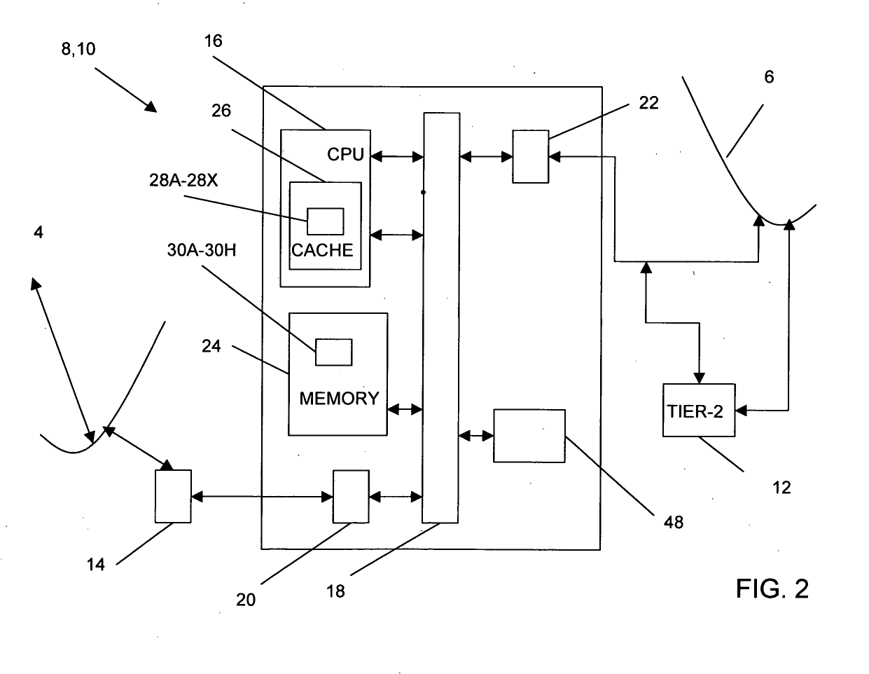

Referring now generally to the Figures and particularly to FIG. 2, FIG. 2 is a schematic drawing of the Tier-1 switches 8 & 10 of the intranet 6 of FIG. 1. A central processing unit 16 is communicatively coupled by means of an internal communications bus 18 with a network interface circuit 20, an intranet interface circuit 22, and a system memory 24. The network interface circuit 20 bi-directionally communicatively couples the Tier-1 switch 8, 10 with the Internet 4 via one or more Internet portals 14. The intranet interface circuit 22 bi-directionally communicatively couples the Tier-1 switch 8, with the Tier-2 system 12 and the intranet 6.

A cache memory 26 of the central processing unit 16 (hereafter “CPU”) includes a plurality of counters 28A-28X that are used to count parameters observed in the examination of the communications traffic received from the Internet 4 by the Tier-1 switch 8, 10. The parameters observed by the Tier-1 switch 8, 10 are defined by one or more sub-profiles 30A-30H. The sub-profiles 30A-30H are maintained in the system memory 24 and/or cache memory 26 and may be updated or edited by the Tier-2 system 12.

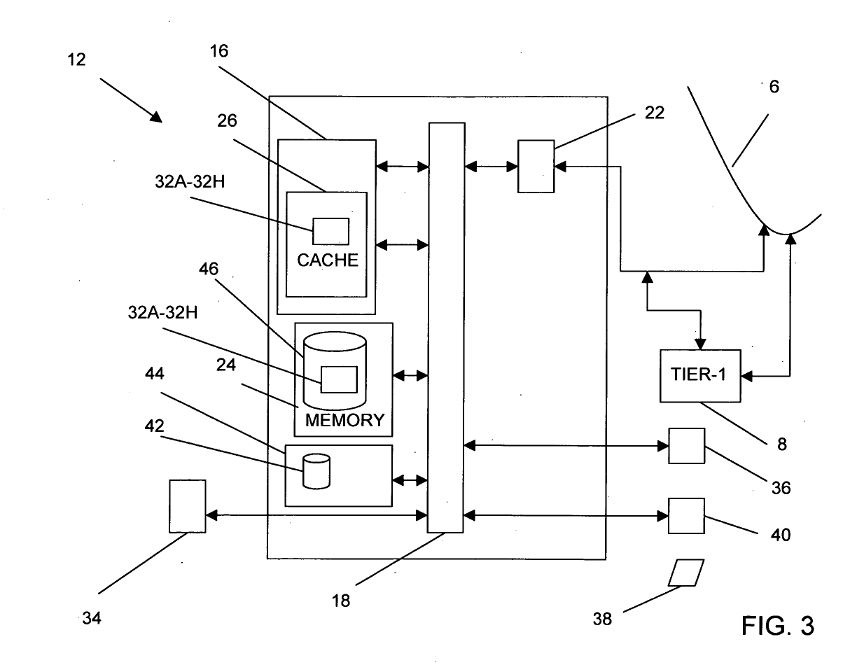

Referring now generally to the Figures and particularly to FIG. 3, FIG. 3 is a schematic drawing of a Tier-2 system 12 of the intranet 6 of FIG. 1. The CPU 16 is communicatively coupled by means of the internal communications bus 18 with an intranet interface circuit 22, and a system memory 24. The intranet interface circuit 22 bi-directionally communicatively couples the Tier-2 system 12 with the Tier-1 switches 8 & 10 and the intranet 6. It is understood that the Tier-1 switches 8 & 10 and the Tier-2 12 switches are comprised within the intranet 6.

One or more Tier-1 switches 8, 10 may comprise, or be comprised within, (1.) a personal computer configured for running WINDOWS XP™ operating system marketed by Microsoft Corporation of Redmond, Wash., (2.) a computer workstation configured to run, and running, a LINUX or UNIX operating system, or (3.) a LANEnforcer secure network switch as marketed by Nevis Networks of Sunnyvale Calif., or (4.) an other suitable computational system known in the art.

The Tier-2 system 12 may comprise, or be comprised within, (1.) a personal computer configured for running WINDOWS XP™ operating system marketed by Microsoft Corporation of Redmond, Wash., (2.) a computer workstation configured to run, and running, a LINUX or UNIX operating system, or (3.) a LANSight secure network server as marketed by Nevis Networks of Sunnyvale Calif., or (4.) an other suitable computational system known in the art.

A plurality of behavioral profiles 32A-32H, or exception profiles 32A-32H, are maintained in the system memory 24 and/or cache memory 26 and are occasionally and/or periodically by the Tier-2 system 12 in accordance with both direction from a system administrator and computational derivations of observed behavior of message traffic and behavior of the electronic communications network 2. The system administrator may program the Tier-2 system 12 by means of the input module 34 and the display peripheral 36. The input module 34 is communicatively coupled with the internal communications bus 18 and may comprise a keyboard and a point-and-click device. The display peripheral 36 is communicatively coupled with the internal communications bus 18 and may comprise a video display.

The system administrator may edit a behavioral profile 32A-32H, or direct the Tier-2 system 12 to modify a sub-profile 30A-30H of a Tier-1 switch 8 & 10 by means of the input module 34 and the display peripheral 26 and/or by communication via the intranet 6.

Additionally or alternatively, behavioral profiles 32A-32H, sub-profiles 30A-30H and machine-readable software-encoded instructions that direct an information technology system to practice the method of the present invention may uploaded from a computer-readable medium 38 and to the Tier-2 system 12 via a media reader 40. The media reader 40 is bi-directionally coupled with the internal communications bus 18 of the Tier-2 system 12 and is configured to read and transfer to the Tier-2 system 12 software-encoded behavioral profiles 32A-32H, sub-profiles 30A-30H and machine-readable instructions

The first version of the method of the present invention applies the Tier-1 switches 8, 10 and the Tier-2 system 12 to provide a two-tiered detection system having the capability of distinguishing between certain malicious and benign attacks in the course of intrusion detection and prevention. Specifically, the first version of the invented method accomplishes intrusion detection and prevention with a reduced incidence of false positives and with lowered detection delay and lowered computational expenditure as compared to the prior art. The invented first version achieves this goal by means of generating and applying behavioral profiles 32A-32H and sub-profiles 30A-30H and using the counters 28A-28X to count the incidence of observed occurrences of parameters specified in at least one sub-profile 30A-30H.

A behavioral profile 32A-32H is defined as a set of events or measured parameters that are observed in sequence and are common or typical across the manifestations of network behavior and/or communications traffic related to a particular type of intrusion attempt or an application. A sub-profile 30A-30H of a behavioral profile 32A-32H may include a set or plurality of values, aspects and/or features that are extracted out from a behavioral profile 32A-32H and that may be selected as showing substantial change during the occurrence of aspects and behavior of the communications traffic or network behavior described by the originating profile 32A-32H. Alternatively, the sub-profile may include parameters and values selected from a profile on the criteria of being more suitable for efficient monitoring by a Tier-1 switch 8 or 10 and/or more likely to be indicative of an intrusion attempt than other aspects of the source behavioral profile 32A-32H.

In the architecture of the first version of the method of the present invention, a Tier-1 switch or systems 8 & 10 perform coarse-grained detection. If a Tier-1 switch does not make a decision with sufficient confidence indicated by a similarity of observed network behavior or communications traffic and a sub-profile 30A-30H stored in the instant Tier-1 switch 8 & 10, the Tier-2 switch 8 & 10 sends information up to a Tier-2 system 12. The Tier-2 system 12 then performs a finer-grain analysis and makes determinations, wherein the observed network behavior or communications traffic is compared for similarity with a profile 30A-30H stored in the instant Tier-2 system 12. If the Tier-2 system 12 determines that the alarm is malicious then the Tier-2 system 12 sends a message back to the Tier-1 switch 8 & 10 to take an action, such as executing an intrusion prevention protocol. Both Tier-1 switches 8 & 10 and Tier-2 systems 12 work together to differentiate malicious and benign attacks to reliably achieve intrusion detection while reducing the incidence of false positive alarms.

Functionalities of the Tier-2 systems 12 can also be transferred to or achieved by one or more Tier-1 switches 8 & 10. This reallocation or redundancy of functionality might require keeping a database in the main memory of the relevant Tier-1 switch 8 & 10 and a matching of every packet or event against the profiles 32A-32H as stored in the Tier-1 switch 8 & 10. As a result, the prior art architecture becomes computationally unfeasible and has enormous impact on the performance. Dividing the intrusion detection task into two tiers in accordance with the method of the present invention achieves the goal of distinguishing malicious attacks from certain benign attacks and reducing false alarms without causing any performance impact.

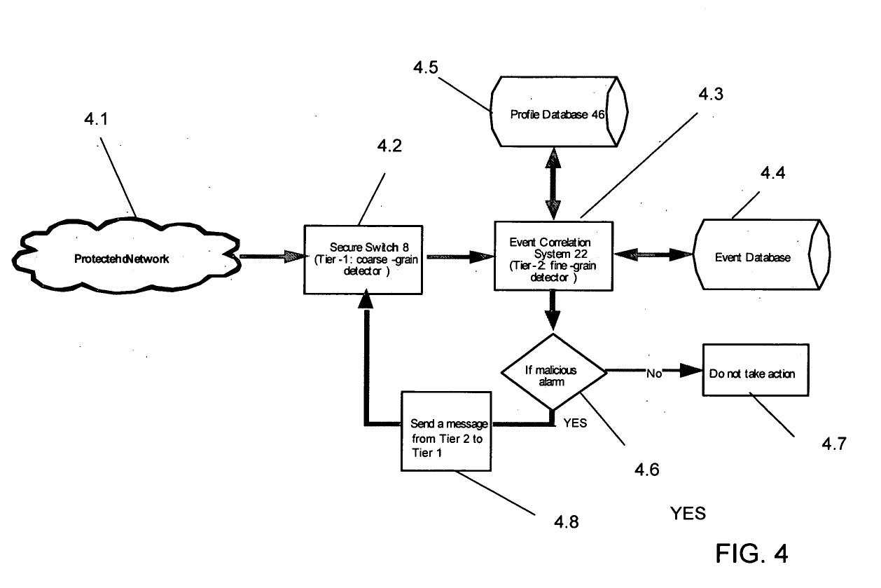

Referring now generally to the Figures and particularly FIG. 4, FIG. 4 is a flow chart that may be executed by the intranet 6, or protected network 6. In step 4.1 communications traffic from the protected network 6 is delivered to the secure Tier-1 switches 8 & 10. In certain yet alternate preferred embodiments of the method of the present invention may provide and employ multiple secure Tier-1 switches 10 and multiple protected networks 6. In step 4.2 the Tier-1 switches 8 & 10 monitor all the traffic received from protected network 6 and generates security and flow events. If there are multiple Tier-1 switches 8 & 10 connected to one Tier-2 system 12, or event server 12, the event server 12 will monitor events transmitted all the communicatively coupled switches. An event correlation module 42 of the Tier-2 system 12 examines the traffic received from the Tier-1 switches in step 4.3 and the Tier-2 system 12 stores events into an event database 46 of the Tier-2 system 12 in step 4.4.

The detection algorithms applying the sub-profiles 30A-30H in the Tier-1 switches 2 as described in FIG. 2 are coarse-grained and are subsets of the information of the profiles 32A-32H of the Tier-2 systems 12. By computing and applying sub-profiles 30A-30H by means of the Tier-1 switches 8 & 10 and using the counters 28A-28X to detect matches between behavior of the electronics communications network 2 and communications traffic observed by the Tier-1 switched 8 & 10, the Tier-1 switches 8 & 10 act as coarse grained detectors that detect activity of the electronic communications network 2 that indicates a possibility of the occurrence of an unwanted intrusion effort. Prior art techniques would typically direct the Tier-1 switch 8 & 10 to immediately issue an intrusion alarm and direct the protected network 6 to take intrusion prevention steps.

Prior art intrusion detection steps would typically place a computational burden on the protected network 6, so avoiding unnecessary alarms in response to a detection of an activity that is either (1.) actually benign, or (2.) classed as benign by either the system administrator or an automated process of the protected network, is desirable. In other words, when the Tier-1 switches 8 & 10 and the Tier-2 systems determine to not issue an unnecessary intrusion alarm the efficiency of the protected network can often be better optimized Information related to each or most intrusion alarms may be sent up to the event correlation module 42 in step 4.4. The event correlation module 42 runs a fine-grained intrusion detector. This fine grained intrusion detector gathers all or many the events related to a specific alarm from the event database 44, builds alarm profiles 32A-32H and compares the newly generated profile 32A-32H against profiles 32A-32H in a profile database 46 as per step 4.5. The profile database 46 includes profiles 32A-32H that are considered to be indicative or false positives or unwanted alarms in any respect. These profiles 32A-32H can be either user-defined or pre-configured. If the new alarm profile 32A-32H matches one of the profiles 32A-32H in the database then the new alarm is counted to be a benign alarm. If there is no match then the new alarm profile is considered to be indicative of a malicious intrusion attempt and that an intrusion alarm shall be issued by the protected network 6. This determination of whether to issue an intrusion alarm is made at the Tier-2 system 12 within the process of FIG. 4 at step 4.6. If the Tier-2 system 12 determines that the information used to create the new profile 32A-32H sent from the Tier-1 switch 8 or 10 either (1.) does not indicate a malicious intrusion attempt, or (2.) matches a pre-existing profile 32A-32H of the profile database 46, the protected network 6 does not take intrusion prevention measures and no intrusion alarm is issued, as per step 4.7.

It is understood that the Tier-2 system 12 may perform as an event correction module and without have a dedicated module hardware 42.

In step 4.8. the Tier-2 system 12 may send a message back to the Tier-1 switch to take configured action for that alarm. If an alarm is determined to be benign accordance with the process of FIG. 3, the Tier-2 system 12 updates various statistics and does not take any action.

The first version of method of the present invention is presented with an illustration of scan detection system. In the same way, this framework can be used for other intrusion detection systems to achieve similar goals.

Today's anomaly based scan detectors face difficulty in distinguishing malicious scans from benign scans. Certain very popular peer-to-peer (hereafter “p2p”) applications such as Skype, Gnutella, Kazaa, and EDonkey scan for participating peers in a p2p network. This scanning behavior is not malicious and is inherent to these applications. Traditional scan detection algorithms such as threshold random walk, sequential hypothesis testing based algorithms, credit-based algorithms that rely on failure rates or number of successes and failures are not able to distinguish between benign application scan and malicious scans. Hence, certain prior art anomaly based intrusion detection techniques generate false positive findings of malicious intrusion attempts, unnecessary intrusion alarms are issued, and computational resources are wasted and impeded in the process of unnecessary intrusion prevention steps.

The first version, and certain still alternate preferred embodiments of the method of the present invention, can be structured and applied to make distinctions between certain malicious and benign scans to eliminate false positives and without greatly affecting detection delay. The approach of the first version essentially ends up delaying the detection for the scans that seem to be potential false positives. These scans are only confirmed after the verifying that they are not any known false positives.

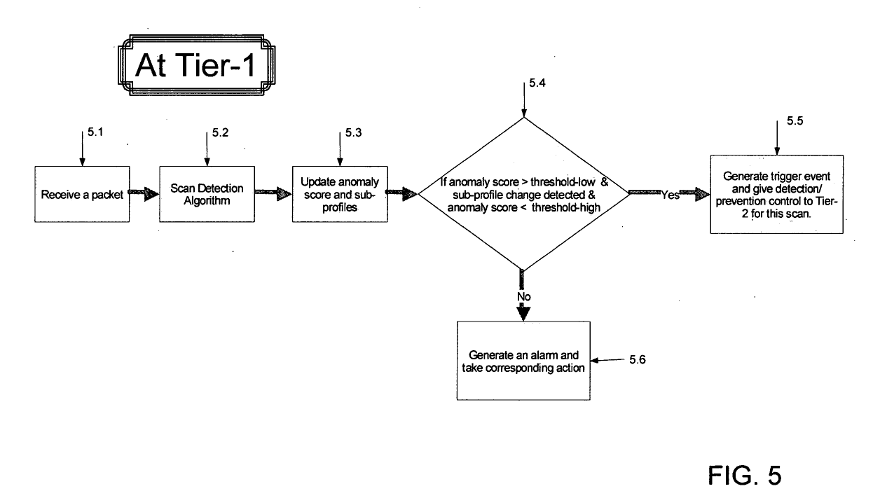

Referring now generally to the Figures and particularly to FIG. 5, a host-based scan detection module 48 system residing within the Tier-1 switches 8 & 10 is applied in a still other alternate preferred embodiment of the method of the present invention. This scan detector 48 is threshold-based and maintains a statistic or a set of statistics that captures behavior of a host into one score, called an anomaly score. If a monitored anomaly score exceeds a predefined threshold this observed behavior indicates a manifestation of potential malicious behavior. Various statistics can be used to accumulate behavior of network activity of the communications network 2 and/or aspects of message traffic observed by the Tier-1 switch 8 or 10 into an anomaly score.

One example of an anomaly score parameter is a count of rate of failures per host, e.g., a Tier-1 switch 8 & 10. Typically, this rate of failures per host is low during normal setting. In contrast, this rate of failures per host is high for scanners since the scanners lack knowledge about the hosts or services running on the hosts. Another example of an anomaly score parameter is the count of observed first-contact failed connections as a sign of malicious behavior and successful connections as a sign of good behavior. A sender of the Internet 4 is penalized for malicious behavior and rewarded for benign behavior. The Tier-1 switches may maintain an anomaly score associated with one or many source computers 15 (hereafter “sources” 15) of the Internet 4 that are sending message traffic to the protected network 6. These anomaly scores are increased upon observation of malicious behavior, and decreased upon observation of benign behavior, by the Tier-1 switches 8 & 10. The amount by which the anomaly score increases or decreases depends on the weights assigned to services. One reason to assign weights associated with each service and is because not all the malicious behavior is equally bad. For example, a failure on an http attempt is less malicious than a failure on an ssh attempt or a failure to connect with a known backdoor port.

Along with maintaining anomaly score, scan detector system also maintains a set of sub-profiles 30A-30H at Tier-1 and corresponding behavioral profiles 32A-32H at Tier-2. Sub-profiles 30A-30H are used to reduce any type of false positive or any unwanted alarms. Since p2p and IM application scans are limitations of most of the scan detection algorithms, an illustration here shows how to make a distinction between malicious scan and benign p2p scan and to eliminate false positives related to p2p applications. Similar approach can be used to identify other applications, applications related false alarm or to reduce unwanted scan alarms. This method can also be used to for other intrusions besides scans.

Continuing to refer particularly to FIG. 5 and generally to the Figures, FIG. 5 is a schematic block diagrams of the application of a scan detection system 48 residing at Tier-1 and according to a second version of the method of present invention. At Tier-1, a received packet in step 5.1 of FIG. 5 is passed on to the coarse grained detector, in this case, the scan detector 48. In step 5.2 the scan detector 48 is applied to the packet received in step 5.1 and the scan detector 48 updates the anomaly score and sub-profiles 30A-30H in step 5.3. Depending on the anomaly score and the sub-profiles 30A-30H, in step 5.4 of FIG. 5, the scan detector 48 determines whether an intrusion alarm should be generated or the information should be passed on to the Tier-2 system 12 for further investigation. When the scan detector 48 determines in step 5.4 that an intrusion alarm is not warranted, the Tier-1 switch 8 may inform the Tier-2 system 12 of the anomaly score and other information related to observed behavior of the communications network 2 and message traffic to enable the Tier-2 system 12 to make a more computationally intensive, and finer grained, analysis to determine whether an intrusion detection alarm shall be issued, as per step 5.5 of FIG. 5. Alternatively, the Tier-1 switch 8 or 10 may determine to issue an intrusion alarm when the observed communications activity and traffic anomalies detected exceed pre-set values.

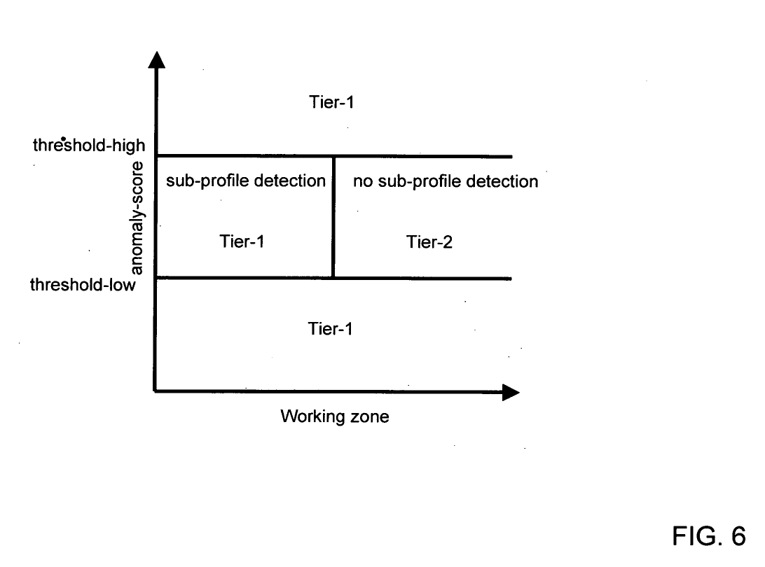

Referring now generally to the Figures, and particularly to FIG. 6, FIG. 6 shows a plurality of working zones for anomaly detection by Tier-1 switches 8 & 10 and Tier-2 systems 12 detectors. There are two sets of thresholds at Tier-1 switches 8 or 10, threshold-low and threshold-high.
If the source's 15 anomaly score exceeds the threshold-high, regardless of any sub-profile match, a Tier-1 switch 8 or 10 will issue an intrusion alarm to the protected network 6 and initiate intrusion prevention actions.
If the source's 15 anomaly score exceeds the threshold-low but smaller than the threshold-high and a sub-profile match is determined then a Tier-1 switch 8 or 10 will send a trigger event, along with information comprising observations of message traffic activity and/or behavior of the communications network 2 to the Tier-2 system 12 and the Tier-2 system 12 perform a determination whether a profile match is found and/or whether intrusion prevention steps should be taken.
If (1.) the source's 15 anomaly score exceeds the threshold-low but smaller than the threshold-high; and (2.) the Tier-1 switch 8 or 10 compares the content of the counters 28A-28X to the sub-profiles 30A-30H and no match is detected then Tier-1 switch 8 or 10 will do the detection and/issue an intrusion alarm to the protected network 6 and initiate intrusion prevention actions.

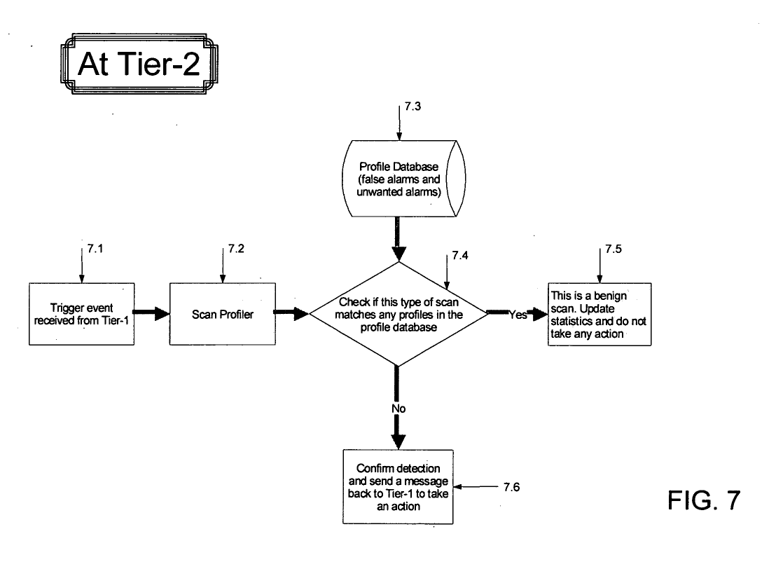

FIG. 7 shows a flow chart in schematic block diagram format of an application of the Tier-2 system 12 acting in accordance with certain yet other alternate embodiments of the method of the present invention. Instep 7.1 of the process of FIG. 7, a trigger event message with observed and related scan information sent by a from Tier-1 switch 8 or 10 is received. In step 7.2 the Tier-2 system 12 builds a profile of a new scan based upon the information received transmitted in step 7.1. In step 7.3 the profile database 46 is accessed, wherein all the profiles 32A-32H of unwanted alarms or false positives are maintained. In this exemplary case, the profiles 32A-32H of p2p and instant messaging applications are stored in the profile database 46. In step 7.4 The Tier-2 system matches this new scan profile (as generated in step 7.2) against all the scan profiles 32A-32H stored in the profile database 46. If a match is found then this scan profile is either known false positive or an unwanted alarm; with a positive finding of a match with an existing profile, the tier-2 system simply updates the statistics of the profile database for the matching profile 32A-32H and does not issue, nor direct a Tier-1 switch 8 or 10 to issue, an intrusion alarm. Statistics maintained might include, for example, a number of positively matched profiles 32A-32H within a time period, or a time when the last profile matched. If there is no profile match found in step 7.4 then the Tier-2 system 12 sends a message back to the Tier-1 switch 8 or 10 to take an action against the source 15.

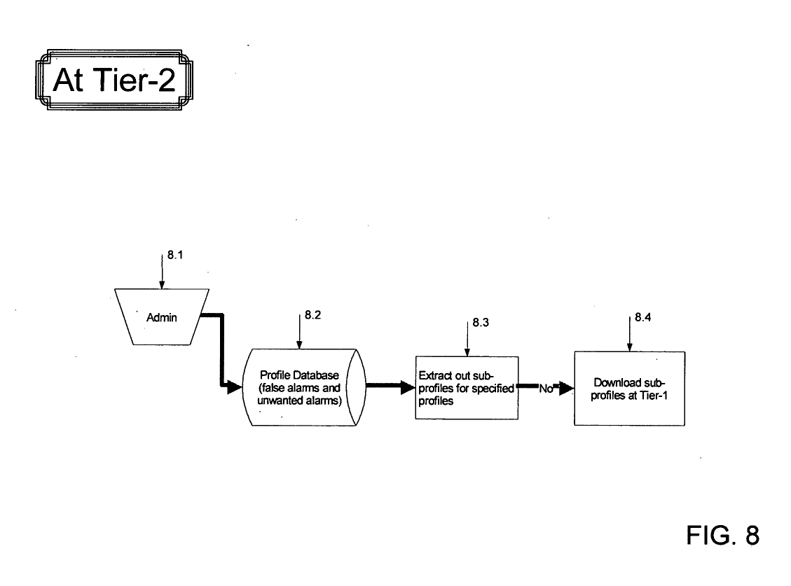

Referring now generally to the Figures and particularly to FIG. 8, FIG. 8 is a flowchart of a third version of the method of the present invention that may be applied to reduce unwanted intrusion alarms within the protected network 6.

The invented system architecture of the third version can be used to reduce unwanted alarms. For example, if there is a specific type of alarm that might be generated upon detection of a certain pattern, or exceeding a certain pattern, of observed communications activity relating to the protected network 6, and the system administrator does not wish for an intrusion alarm to be issued in response to the detection of this pattern, the system administrator can create a behavioral profile 32A-32H of that activity and create a profile and write the new profile into the profile database as shown in steps 8.1 and 8.2 of the process of FIG. 5. When a new profile is added, a sub-profile process of the Tier-2 system may compute sub-profiles 30A-30H for that newly generated profile in step 8.3. The extracted sub-profile is then sent down the secure Tier-1 switches 8 & 10 in step 8.4 of the process of FIG. 8. In this way, new profiles 32A-32H can be added and this framework can be used to suppress unwanted alarms.

The profiles 32A-32H kept at the profile database 46 at the Tier-2 system 12 can be very detailed. On the contrary, the sub-profile 30A-30H at maintained at the Tier-1 switches 8 & 10 can be very coarse, as simple as, keeping counters 28A-28X. There is a tradeoff between the making the sub-profiles 30A-30H coarse and adding delay due to Tier-2 hand offs, and the decision making time taken by the Tier-2 system 12. One way to balance this tradeoff is by knowing what alarms are critical in the protected network 6 and which alarms tend to have more false positives and use sub-profiles 30A-30H for only those alarms.

The method of the present invention provides a high-speed and low-memory architecture, e.g., counters in Tier-1 switches 8 & 10, applied to efficiently gather data used to eliminate unwanted alarms. One exemplary application is in a scan detection embodiment wherein the incidence of false positives of intrusion alarms issued due to observations by one or more Tier-1 switches of benign p2p activity are reduced.

Another exemplary use of the method of the present invention includes a goal of eliminating unnecessary intrusion alarms triggered by detections of internal horizontal scans on port 445. Where the observed behavior is the number of failures on port for time between when anomaly score is zero until the anomaly score is higher than a threshold_low. A counter 28A may be incremented from a zero value and by a value of one every time the observed behavior is detected by the instant Tier-1 switch 8 or 10. If the counter value is higher than a certain threshold_low value then there is a match with a sub-profile 30A. The sub-profile 30A has been extracted from a profile 32A, and the profile 32A may compare observed network activity that includes the number of failures on port 445 where destination IP is internal.

Another exemplary use of the method of the present invention includes a goal of eliminating unnecessary intrusion alarms triggered by detections of Skype scans. Where the observed behavior is number of failures on destination port higher than 1024 for time between anomaly score is zero until anomaly score is higher than threshold_low. A counter 28B may be incremented from a zero value and by a value of one every time the observed behavior of a failures on destination port higher than 1024 is detected by the instant Tier-1 switch 8 or 10. If the counter value is higher than a certain threshold_low value then there is a match with a sub-profile 30B. The sub-profile 30A has been extracted from a profile 32B, and the profile 32B may compare observed network activity that includes (1.) a count of flow failures to Skype login-servers, and (2.) a count of flow failures to Internet IP address on ports higher than 1024.

The use of counters of the Tier-1 switches 8 & 10 to first filter out observed behaviors that might not be grounds for issuing an intrusion alarm thereby provides a rapid technique that requires little computational resource nor time to achieve reductions the incidence of unwarranted intrusion alarm issuance.

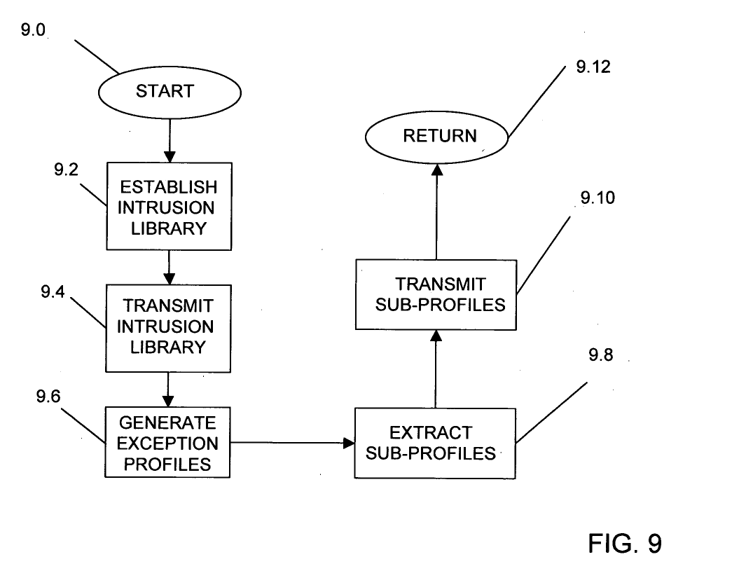

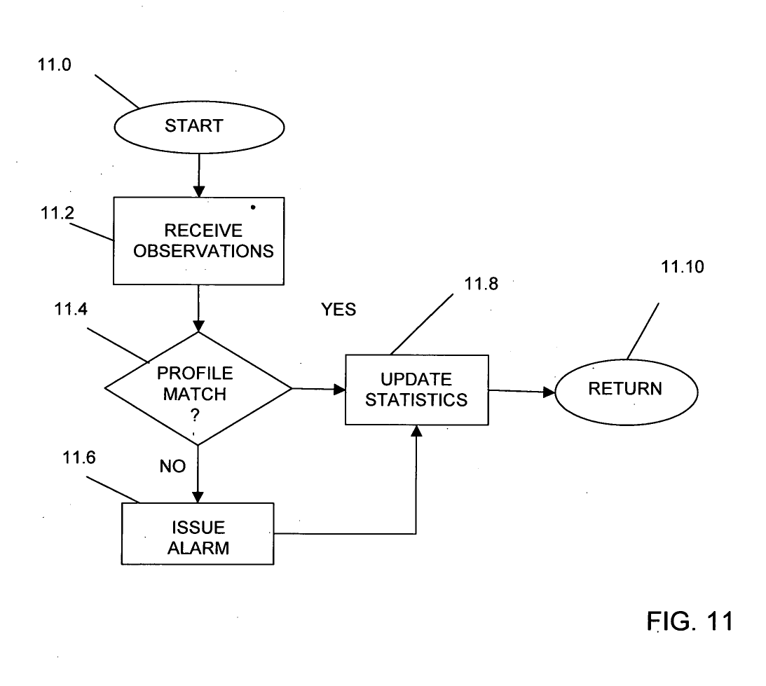

Referring now generally to the Figures and particularly to FIGS. 9, 10 and 11, FIG. 9 is a flowchart of operations of the Tier-2 system 12 of FIGS. 1 and 3 and in accordance with a fourth alternate preferred embodiment of the method of the present invention (hereafter “fourth method”). In step 9.2 the Tier-2 system 12 establishes a library of intrusion detection information that enables the Tier-1 switches 8 & 10 and the Tier-2 system 12 to determine whether an intrusion attempt may be in-process. The intrusion library information is stored in the Tier-2 system 12 and may contain signatures of message traffic behavior and contents, and/or observed behavior of the communications network 2, previously observed during the implementation of an intrusion attempt. Additionally or alternatively, the intrusion library information may include algorithms and/or historical data that enable the Tier-1 switches 8 & 10 and the Tier-2 system 12 to analyze observations of message traffic behavior and contents, and/or behavior of the communications network 2, for anomalous indications of a possibility of a detection of an intrusion attempt.

In step 9.4 all or some of the information of the intrusion detection library id transferred from the Tier-2 switch 12 to one or more Tier-1 switches 8 & 10. The intrusion detection library includes machine-readable data and instructions enable the recipient Tier-1 switches 8 & 10 to analyze observations of message traffic behavior and contents, and/or behavior of the communications network 2, for anomalous indications of a possibility of a detection of an intrusion attempt.

In step 9.6 the Tier-2 system generates the profiles 32A-32H. These exception profiles 32A-32H include information identifying combinations of aspects, values, behaviors and/or content of message traffic and/or the communications network 2 that when observed by a Tier-f switch 8 & 10 and/or the Tier-2 system 12 might be interpreted, in accordance with the intrusion detection library, as grounds for the observing Tier-1 switch 8 & 10 and/or the Tier-2 system 12 to generate an intrusion alarm. However when a match is found between one or more of the exception profiles 32A-32H and observed message traffic and/or behavior of the communications network 2, the Tier-1 switches 8 & 10 are directed by the Tier-2 system 12 to not issue an intrusion alarm. In this way undesired intrusion alarms, to include false positive findings of intrusion attempt detections, are reduced by the application of the fourth method.

In step 9.8 the Tier-2 system 12 selects and derives and/or extracts values from exception profiles 32A-32H and writes these values into the sub-profiles 30A-30H. The values read into the sub-profiles 30A-30H are selected to be related to parameters of message traffic behavior and/or contents, and/or aspects of behavior of the network 2, that may be observed by the recipient Tier-1 switch 8 & 10 and the incidence of which can be counted by incrementing the counters 28A-28X.

In step 9.10 the sub-profiles 30A-30H are transmitted from the Tier-2 system to one or more Tier-1 switches 8 & 10. It is understood that the transmission of step 9.10 may be an update and/or a refresh of sub-profiles 30A-30H that have previously provided to the recipient Tier-1 switch 8 & 10. It is further understood that aspects or portions of the library of intrusion detection information, one or more exception profiles 32A-32H, and/or one or more of the sub-profiles 30A-30H may be provided to the Tier-2 system 12 and/or one or more Tier-1 switch by input from the system administrator or upload from the computer-readable medium 38. The Tier-2 system 12 proceeds on from step 9.10 to step 9.12 and alternate processing: it is understood that this alternate processing may include a return to step 9.2 through 9.10 and/or a cessation of intrusion detection operations.

Referring now generally to the Figures and particularly to FIGS. 9, 10 and 11,

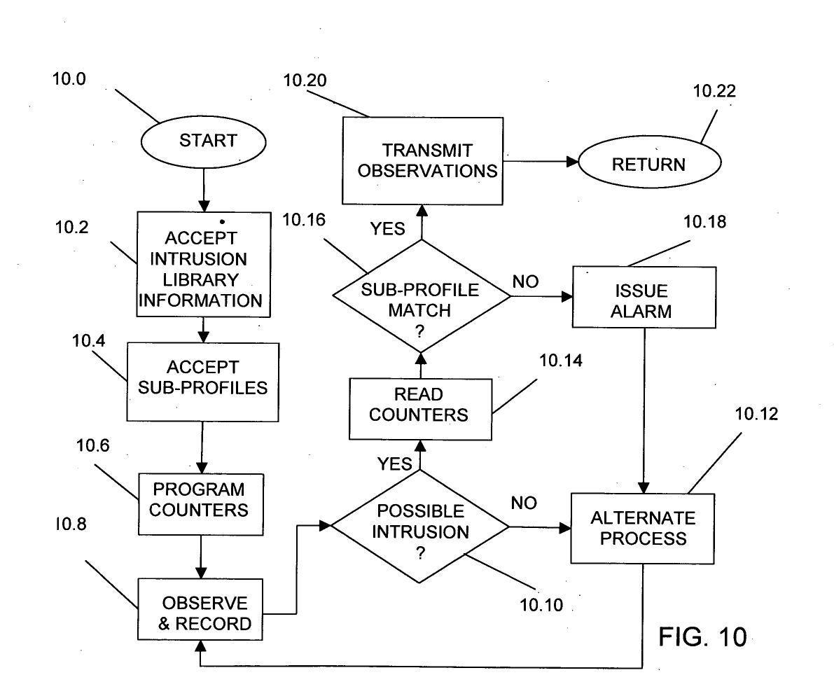

FIG. 10 is a flowchart of operations of a Tier-1 switch 80r 10 of FIGS. 1 and 2 and in accordance with the fourth method. In step 10.2 a Tier-1 switch 8 accepts information of the intrusion detection library from the Tier-2 system 12 and stores the received information in system memory.x. In step 10.4 the Tier-1 switch 8 accepts sub-profiles 30A-30H from the Tier-2 system 12. It is understood that alternatively the Tier-1 switch 8 might be programmed to partially or wholly derive one or more sub-profiles 30A-30H, in whole or in part, and/or receive sub-profile content information as input from the system administrator or upload from the computer-readable medium 38.

In step 10.6 the Tier-1 switch 8 programs or otherwise dedicates the counters 28A-28X to count observable aspects and parameters of message traffic and/or behavior of the communications network 2 in accordance with the values of the sub-profiles 30A-30H. In step 10.8 the Tier-1 switch 8 observes behavior of the communications network 2 and/or the behavior and contents of the message traffic received by the Tier-1 switch 8.

In step 10.10 the Tier-1 switch 8 determines whether the observed aspecst of message traffic and/or network behavior indicates the occurrence of a possible intrusion. This determination of step 10.10 is made in accordance with the intrusion detection library information received in, and possibly previous to, step 10.2. Where no intrusion detection attempt is determined to be observed, the Tier-1 switch 8 proceeds from step 10.10 to step 10.12 and performs alternate processing. It is understood that this alternate processing of step 10.12 may include a return to step 10.2 through 10.10 and/or a cessation of intrusion detection operations.

When an intrusion attempt is determined to be detected by the Tier-1 switch 8 in step 10.10, the Tier-1 switch 8 reads the values of one or more counters 28A-28X in step 10.14 and compares the read counter values to the stored values of the sub-profiles 30A-30H in step 10.16. When a match is not found in step 10.16 between the observed aspects and behavior of message traffic and/or network behavior, the Tier-1 switch 8 issues an intrusion alarm in step 10.18 and proceeds on from step 10.18 and to alternate processing of step 10.12.

Where a match is found in step 10.16 between the observed aspects and behavior of message traffic and/or network behavior of step 10.8, the Tier-1 switch 8 proceeds from step 10.16 to step 10.20 and transmits some or all of the observed aspects and behavior of message traffic and/or network behavior of step 10.8 to the Tier-2 system 12.

The Tier-1 switch 8 proceeds on from step 10.20 to perform the alternate processing of step 10.22. It is understood that this alternate processing of step 10.22 may include a return to step 10.2 through 10.10 and/or a cessation of intrusion detection operations. It is further understood that the steps 10.0 through 10.22 may be executed by one or more additional Tier-1 switches 10.

Referring now generally to the Figures and particularly to FIGS. 9, 10 and 11, FIG. 11 is a flowchart of additional operations of the Tier-2 system 12 of FIGS. 1 and 3 and in accordance with the fourth method. In step 11.2 the Tier-2 system 12 receives information containing observed aspects and behavior of message traffic and/or network behavior from the Tier-1 switch 8. In step 11.4 the Tier-2 system 12 compares some or all of the information received in received in step 11.2 with the library of exception profiles 32A-32H. When a match is not found between the comparison in step 11.4 between information received in step 11.2 and at least one exception profile 32A-32H, then the Tier-2 system 12 issues an intrusion alarm to the protected network 6 and/or directs one or more Tier-1 switches 8 & 10 to issue an intrusion alarm. When no match is found in step 11.4, the Tier-2 system 12 proceeds directly from step 11.4 to step 11.8, whereby a statistics history maintained in the system memory of the Tier-2 system 13 is updated with the information received in step 11.2.

The Tier-2 system 12 proceeds on from step 11.8 to step 11.10 and alternate processing: it is understood that this alternate processing of step 11.10 may include a return to step 9.2 through 9.10 and/or a cessation of intrusion detection operations.

The terms “computer-readable medium” and “computer-readable media” as used herein refers to any suitable medium known in the art that participates in providing instructions to the an electronic information technology system, including the Tier-1 switch 8 & 10 and Tier-2 system 1, for execution. Such a medium may take many forms, including but not limited to, non-volatile media, volatile media, and transmission media. Non-volatile media includes, for example, optical or magnetic disks, such as storage device 38. Volatile media includes dynamic memory. Transmission media includes coaxial cables, copper wire and fiber optics.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, and any other memory chip or cartridge from which a computer, such as the Tier-1 switch 8 & 10 and Tier-2 system 12, can read.

Various forms of computer readable media may be involved in carrying one or more sequences of one or more instructions to the network for execution. For example, the instructions may initially be carried on a magnetic disk of a remote computer. The remote computer can load the instructions into its dynamic memory and send the instructions over a telephone line using a modem. A modem local to or communicatively linked with the network can receive the data on the telephone line and use an infra-red transmitter to convert the data to an infra-red signal.

The foregoing disclosures and statements are illustrative only of the Present Invention, and are not intended to limit or define the scope of the Present Invention. The above description is intended to be illustrative, and not restrictive. Although the examples given include many specificities, they are intended as illustrative of only certain possible embodiments of the Present Invention. The examples given should only be interpreted as illustrations of some of the preferred embodiments of the Present Invention, and the full scope of the Present Invention should be determined by the appended claims and their legal equivalents. Those skilled in the art will appreciate that various adaptations and modifications of the just-described preferred embodiments can be configured without departing from the scope and spirit of the Present Invention. Therefore, it is to be understood that the Present Invention may be practiced other than as specifically described herein. The scope of the Present Invention as disclosed and claimed should, therefore, be determined with reference to the knowledge of one skilled in the art and in light of the disclosures presented above.

I claim:

1. In a computer network having a switch and an event correlation computer, a method of intrusion detection, the method comprising:
establishing a library of profiles accessible to the event correlation computer, each profile comprising a record of observable conditions that when detected in combination indicate the potential occurrence of an intrusion attempt;
providing a library of sub-profiles to the switch, each sub-profile comprising a subset of the observable conditions of a unique profile;
enabling the switch to examine communications traffic and determine when the behavior of the communications traffic matches any one of the sub-profiles; and
directing the switch to inform the event correlation computer upon detection of a match between contemporaneously detected communications traffic and at least one sub-profile.

2. The method of claim 1, wherein the computer network further comprises a plurality of switches, each switch communicatively coupled with the event correlation computer and each switch comprising a library of sub-profiles, whereby each switch is enabled to examine communications traffic and determine when the behavior of the communications traffic matches any one of the sub-profiles, and each switch informs the event correlation computer upon detection of a match between contemporaneously detected communications traffic and at least one sub-profile.

3. The method of claim 1, wherein the switch is communicatively coupled with a computer network selected from the group consisting of the Internet, an intranet, an extranet, a telephony system, and an electronic communications network.

4. The method of claim 1, wherein the method further comprises:
providing the event correlation computer with a sampling of the contemporaneously detected communications traffic; and
directing the event correlation computer to determine whether the sampling includes a plurality of observable conditions matching at least one profile that when detected in combination indicate the potential occurrence of an unwanted alarm or a false positive.

5. The method of claim 4, wherein the event correlation computer directs the switch to trigger an intrusion detection alarm when the sampling includes a plurality of observable conditions of at least one profile that when detected in combination indicate the potential occurrence of an unwanted alarm or a false positive finding of an intrusion attempt.

6. The method of claim 4, wherein the event correlation computer triggers an intrusion detection alarm when the sampling includes a plurality of observable conditions matching at least one profile that when detected in combination indicate the potential occurrence of an intrusion attempt.

7. The method of claim 4, wherein the method further comprises:
providing a library of benign profiles to the event correlation computer, each benign profile comprising a record of observable conditions that when detected in combination shall direct the event correlation computer to not initiate an intrusion alarm;
directing the event correlation computer to compare the sampling with the library of benign profiles when the sampling includes a plurality of observable conditions matching at least one profile that when detected in combination indicate the potential occurrence of a benign alarm; and
directing the event correlation computer to not issue an intrusion alarm when the sampling matches a benign profile.

8. The method of claim 7, wherein the computer network further comprises a plurality of switches, each switch communicatively coupled with the event correlation computer and each switch comprising a library of sub-profile, whereby each switch is enabled to examine communications traffic and determine when the behavior of the communications traffic matches any one of the sub-profiles, and each switch informs the event correlation computer upon detection of a match between contemporaneously detected communications traffic and at least one sub-profile.

9. The method of claim 7, wherein the switch is communicatively coupled with a computer network selected from the group consisting of the Internet, an intranet, and extranet, a telephony system, and an electronic communications network.

10. The method of claim 7, wherein at least one benign profile describes a set of observable conditions of a false positive communications traffic behavior.

11. The method of claim 7, wherein at least one benign profile is modified on the basis of communications traffic observed by the switch.

12. The method of claim 8, wherein at least one benign profile is modified on the basis of communications traffic observed by at least two switches.

13. In a computer network comprising a tier-1 intrusion detector and a tier-2 intrusion detector, a method for reducing an incidence of undesired intrusion alarms, the method comprising:
setting a threshold-low for host's anomaly score and a threshold-high for host's anomaly score;
directing the tier-1 intrusion detector to initiate intrusion counter measures when a source's anomaly score exceeds the threshold-high; and
directing the tier-2 intrusion detector to determine whether to initiate intrusion counter measures when a source's anomaly score exceeds threshold-low and does not exceed the threshold-low.

14. The method of claim 13, the method further comprising:
directing the tier-1 intrusion detector to transmit a trigger event message to the tier-2 intrusion detector when there is at least one sub-profile match; and
enabling the tier-2 intrusion detector to determine whether to initiate intrusion counter measures.

15. The method of claim 14, the method further comprising enabling the tier-1 intrusion detector to determine whether to initiate intrusion counter measures when no sub-profile match is detected.
Please replace “a change in sub-profile” to “a sub-profile match” or “sub-profile detection”.

16. The method of claim 13, wherein the computer network further comprises a plurality of tier-1 intrusion detectors, each tier-1 intrusion detector communicatively coupled with the tier-2 intrusion detector and each tier-1 intrusion detector comprising a library of sub-profiles 32A-32H, whereby each tier-1 intrusion detector is enabled to examine communications traffic and determine when the behavior of the communications traffic matches any one of the sub-profiles 32A-32H, and each tier-1 intrusion detector informs the tier-2 intrusion detector upon detection of a match between contemporaneously detected communications traffic and at least one sub-profile.

17. The method of claim 13, wherein the tier-1 intrusion detector is communicatively coupled with a computer network selected from the group consisting of the Internet, an intranet, and extranet, a telephony system, and an electronic communications network.

18. The method of claim 13, the system further comprising:
means for directing the tier-1 intrusion detector to transmit a trigger event message to the tier-2 intrusion detector when there is sub-profile match detection; and
means for enabling the tier-2 intrusion detector to determine whether to initiate intrusion counter measures upon receipt of the trigger event message.

19. An electronic communications system, the system comprising:
a tier-1 intrusion detector and a tier-2 intrusion detector;
means for setting a threshold-low and a threshold-high;
means for directing the tier-1 intrusion detector to initiate intrusion counter measures when a source exceeds the threshold-high traffic anomaly score; and means for directing the tier-2 intrusion detector to determine whether to initiate intrusion counter measures when a source anomaly score exceeds threshold-low traffic anomaly score and does not exceed the threshold-low traffic anomaly score.

20. A computer-readable media comprising software-encoded instructions that direct an information technology system to practice the method of claim 1.
